(19) United States
(12) Patent Application Publication
(10) Pub. No.: US 2013/0304272 A1
(43) Pub. Date: Nov. 14, 2013

(54) METHOD FOR OPERATING A LOCAL ENERGY NETWORK

(71) Applicants: Johannes-Alexander Schaut, Kornwestheim (DE); Friedrich Schoepf, Sternenfels-Diefenbach (DE); Markus Brandstetter, Sachsenheim (DE)

(72) Inventors: Johannes-Alexander Schaut, Kornwestheim (DE); Friedrich Schoepf, Sternenfels-Diefenbach (DE); Markus Brandstetter, Sachsenheim (DE)

(21) Appl. No.: 13/884,837

(22) PCT Filed: Sep. 27, 2011
(86) PCT No.: PCT/EP2011/066712

§ 371 Date: Jul. 18, 2013

(30) Foreign Application Priority Data
Nov. 11, 2010 (DE) 10 2010 043 752.2

(51) Int. Cl. H02J 4/00

(52) U.S. Cl. CPC H02J 4/00
USPC 700/295

(57) ABSTRACT

A method and a system are presented for operating a local energy network that has a limited network utilization and in which a plurality of loads can be connected via a power network. An energy requirement of each load is detected, and an allocation of the available energy to the loads takes place as a function of a maximum utilization of the energy network. At the same time, communication is enabled.

### FIELD OF THE INVENTION

The present invention relates to a method for operating a local energy network and to a system for carrying out the method.

### BACKGROUND INFORMATION

Local energy networks include a number of loads whose energy requirement has to be ensured in the network in order to ensure the functional capacity of the network as a whole. Thus, for example in private households it should be ensured that sufficient energy, generally electric energy, is available at all times. Here it is to be noted that in households only a limited quantity of electric power is provided, which is limited for example in houses and buildings via a central main circuit breaker. This is problematic in particular during periods of time in which a peak load is demanded. This problem is exacerbated by the increasing number of electric loads. Here it is to be noted in particular that, increasingly, energy storage devices of electric vehicles are charged via the household network.

All electric vehicles currently in development are charged either by plugging into a normal outlet, a three-phase power supply, or through an exchangeable battery design. The charge power is from 3 kW to 12 kW. In isolated cases, there are also approaches to fast charging using direct voltage, with up to 30 kW. However, the charging devices required for this are very expensive, so that at this time their use in private households appears unlikely.

U.S. Pat. No. 7,373,222 describes a method for carrying out a decentralized load management in a system in which a number of loads are provided that are connected to the system. The loads are assigned to classes. In addition, control units connected to one another in a network are provided that are assigned to the loads. These work together in order to decide to which loads energy is allocated. For this purpose, priorities can be assigned to the loads. For the querying of the control units, a main or master control unit is provided.

A charging and discharging strategy that takes into account both different goals, such as energy prices, charging speed, network utilization, battery status, frequency of use, and CO₂ emissions, does not exist. This prevents the vehicle owner from being able to carry out a charging and discharging of the vehicle battery in accordance with his wishes. The charging strategy is determined by the connection of the electric vehicle to the power network by the driver, who is neither informed about the charging state of the power network nor is able to determine the costs of the charging via flexible rates.

However, in the future this will no longer be acceptable. On the basis of the scenarios concerning increasingly widespread use of electric vehicles, these vehicles will preferably be found in residential areas having access to a power connection in a protected garage, and within commuting distance of workplaces.

### SUMMARY

Against this background, a method is presented for operating a local energy network, and a system is presented for carrying out the method.

With the presented method and the described system, a load manager can be realized in a local energy network by which the named problems can be solved and further functions can be realized. This load manager is for example integrated in a control device, and enables communication with the users, a building-internal exchange of connected devices with one another, and communication with other buildings or energy networks.

Thus, a system is presented for load and supply management, which, in particular in connection with electric vehicles, is suitable for automatic controlling of the charging and discharging of vehicle batteries, taking into account freely selectable target parameters such as cost, CO₂ emissions, charging speed, network utilization, battery status, or frequency of use. This is achieved with specified physical boundaries, such as voltage, frequency of the vehicle, with simultaneous prevention of overloading of the building connection or household connection.

It is to be noted that the combination of factors, in particular constantly increasing energy costs, the substitution of primary energy consumption by electric power loads (electric vehicles or heat pumps), in particular in private households, and the introduction of digital counters by legislatures, requires a load management in the household that both operates within the household and also adapts the load across a plurality of buildings. Only in this way can a significant contribution to energy efficiency, while however also providing economical usage for network operators and end customers, result from the operation of electric vehicles.

The presented load manager for electric vehicles avoids the overloading of the building connection technology, and optimizes the costs of buying electric power in accordance with price signals in the power network. In addition, the load manager enables participation in the balancing energy market, whereby, on the one hand, the owner of the vehicle can take advantage of income potential, and on the other hand network expansion is avoidable for the network operator.

In addition, a qualitative improvement of the supply network is enabled by the entry of the electric vehicles to the market. Here it is to be noted that local power bottlenecks can also be compensated locally, up to avoidance of blackouts in the building. The approach to load management proposed here meets the requirements of communication both in the supply network and also within the building, and ensures simple operation for the end user.

With the following method and the presented system for carrying out the method, the following tasks can be achieved in at least some of the embodiments:
avoidance of the overloading of the household connection due to the entry of electric vehicles into the building infrastructure,
avoidance of electric power network expansion due to the entry of electric vehicles into the market,
minimization of energy costs for the charging of electric vehicles,
supporting of the sale of battery storage capacity on the market,
compensated optimization of network quality,
realization of an emergency power function for the building based on the vehicle battery (optional),
immediate visualization of the energy consumption, namely temporal progress and total, via suitable display devices such as computers and smartphones; transmission via LAN, power lines, etc.

Further advantages and embodiments of the present invention result from the description and the accompanying drawings.

Of course, the features named above and explained in the following may be used not only in the respectively indicated combinations, but also in other combinations or alone, without departing from the scope of the present invention.

### BRIEF DESCRIPTION OF THE DRAWINGS

FIG. 1 shows an overload in a household connection.

FIG. 2 illustrates the requirement for expansion in residential areas.

FIG. 3 shows a positioning of a load manager at an interface between the building and the service provider.

FIG. 4 shows a specific embodiment of the described system.

### DETAILED DESCRIPTION

The present invention is schematically shown on the basis of specific embodiments in the drawings, and is explained in detail below with reference to the drawings.

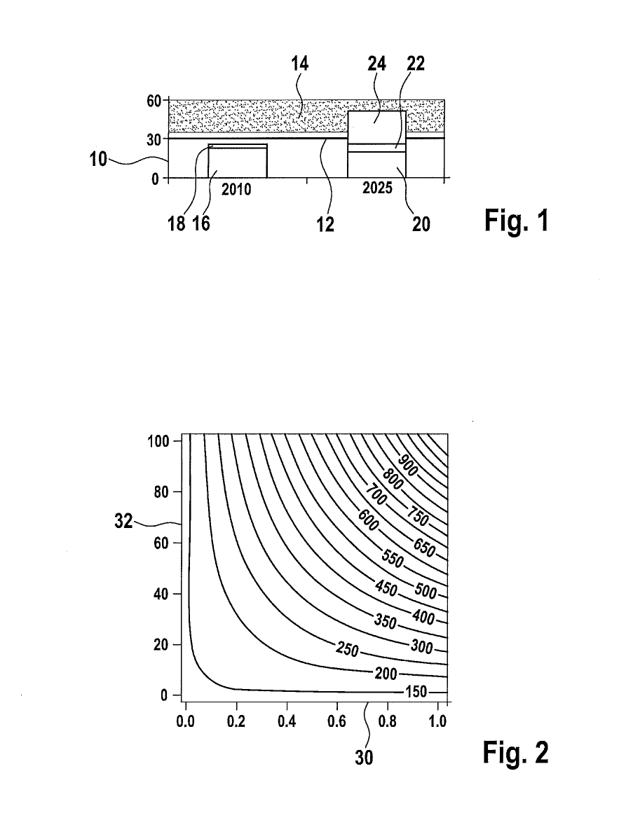

FIG. 1 shows an overload in a household connection. In the drawing, electrical power in kW is plotted on an ordinate 10. A threshold 12 is plotted at 30 kW; beyond this is an overload region 14 of the household connection. The drawing shows, for the year 2010, the power requirements and thus the energy requirements of the loads in the house, which in this case represents the local energy network. A first clock 16 indicates the power requirements of the household devices, and a second black 18 indicates the requirements for heating and air conditioning. The drawing shows that the power requirements in the house as a whole remain below threshold 12.

A corresponding division of the energy requirements is also plotted for the year 2025. Again, a first block 20 is shown for the requirements of the household devices, and a second block 22 is shown for heating and air conditioning. In addition, there is a third block 24 for electric mobility, and thus for one or more electric vehicles whose energy storage devices, or batteries, are to be charged via the local network. FIG. 1 shows that an overload will occur, and the main circuit breaker will therefore be triggered.

This is explained on the basis of the following scenarios, with reference to FIG. 1.

According to a first scenario, the electric vehicle is plugged into the household connection in the evening after the daily trip to work. The charging begins at once. At the same time, in the evening other loads in the household are also connected to the network, such as the oven, television set, washing machine, heat pump, etc. Due to the simultaneous energy requirement of all the loads, there will quickly occur an overload of the normal household connection, which is standardly secured with a 30 kW main circuit breaker. This has the consequence that the main circuit breaker separates the building from the network.

According to a second scenario, vehicles traveling homeward have a high degree of simultaneity. The loads connected parallel thereto are also high. This causes a significant load peak, because there is nothing for temporally offsetting these loads, in particular the electric vehicles, or even using them as storage devices or network stabilization elements. The consequences of this are excessive network expansion, excessive current peaks, and therefore expensive reserve capacities that have to be maintained.

FIG. 2 shows, in a graph, a simulation of a highly expanded network having high reserves. A simultaneity factor is plotted on an abscissa 30, and vehicle penetration per household in % is plotted on an ordinate 32. In the graphs, curves are plotted of transformation power levels, in kVA. The representation illustrates the expansion requirement, determined via simultaneity and portion of the electric vehicles in residential areas.

The simulation demonstrates that, on the basis of a simultaneity factor that is to be assumed to be fairly high, expansion measures become necessary very quickly even in residential areas if intelligent load management is not implemented. Already today, power suppliers are considering supporting private solar plants with converters for low-voltage networks, purely out of these considerations of quality.

The presented intelligent system for load and supply management, provided in particular in connection with the charging of electric vehicles in a household connection, solves the presented problem.

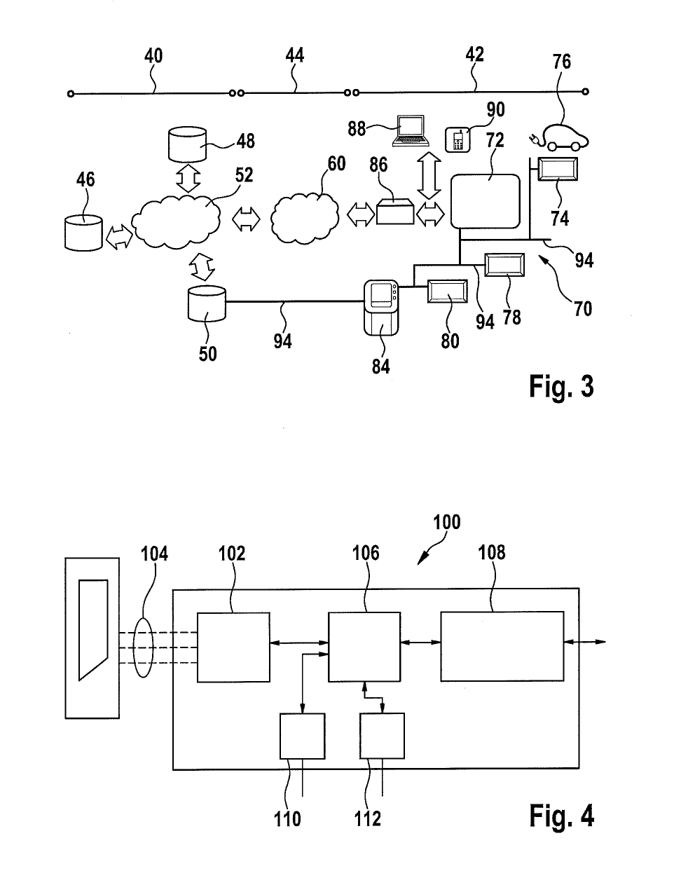

FIG. 3 shows the positioning of a load manager at the interface between the building and the service provider. The Figure places the supplier or service provider 40 opposite a building 42, and an interface 44 is provided between supplier 40 and building 42.

At the supplier 40, three blocks are shown purely schematically, namely a first block 46 for a decentralized energy supplier and a virtual network, a second block 48 for service providers for the sale of electric power and for electric vehicles, and a third block 50 for suppliers, rates, and price signals. The three blocks 46, 48, and 50 are connected to one another via Web services 52.

In this case, interface 44 is realized via an IP connection 60. The communication can take place for example via a power network line, or also via a DSL line.

Local energy network 70 is provided in building 42. This network includes a system 72 for operating energy network 70, also designated the load manager, a first connection 74 for an electric vehicle 76, a second connection 78 for heating and air conditioning, and a third connection 80 for the oven and further household devices.

Furthermore, in building 42 are provided a digital power measuring device (smart meter) 84, a unit 86 for a data gateway and a laptop 88, and a mobile device 90, e.g. a mobile telephone, for visualization in order to provide information to the user or occupant of building 42. However, these devices can also be used for inputting user instructions.

The communication takes place for example via power line 94, using so-called power line communication, and, in particular outside the building, via IP via DSL or IP via power line.

FIG. 3 shows the networking of load manager 72 at the interface 44 between building 42 and service providers 40. Here, communication via power line and IP is completely sufficient. Load manager 72 itself is to be installed with minimum outlay, because it can either detect the total load of building 42 via digital power measuring device 84, or, alternatively, can determine it via induction clamps on the household connection itself.

The wiring of the loads takes place for example at connections 74, 78, and 80 of the loads themselves, e.g. via communication-capable outlets, and/or via a fuse box in which controllable fuses are situated. Here, for the function of load manager 72 the switching of the large loads is sufficient to prevent the so-called blackout of the house, and to ensure the desired comfort function of the economical vehicle charging and provision of storage energy from vehicle 76 (inverse operation). Standardly, load manager 72 includes a first unit for detecting an energy requirement of each load, and a second unit for allocating the available energy or power to the loads as a function of a maximum utilization of energy network 70.

The matching with the end user via desired charging scenarios can for example include an immediate charging of the vehicle, a prioritization of the loads (e.g. heat pump priority 3), and can take place either via mobile telephone 90, laptop 88, or a display device. Here, usefully data-secure communication scenarios are used that, in further expansion stages, also support the sale of balanced energy via third-party suppliers, or automated dealing with third-party power suppliers, such as decentralized energy suppliers.

FIG. 4 shows a specific embodiment of the described system 100 in a schematic representation. This system 100, also designated load manager and integrated in a central control device, includes a power line interface 102 that receives and sends data (IP) via power line 104. In addition, an integrated circuit system 106, standardly an electronic computing unit, interfaces 108 for devices and building control systems, and an interface 110 for LAN and an interface 112 for WAN are provided.

Integrated circuit system 106 enables a multi-channel measurement of effective and apparent power, using power measurement coils that can be attached to existing installation lines without galvanic contact. The current and power measurement typically takes place at the multi-phase household connection, and additionally at a plurality of fuse circuits for the individual detection of current circuits and loads.

The current measurement coils can be realized in a folding embodiment, also known as a so-called split core, in order to enable an easy retrofit in an existing installation without wiring changes. The power and energy consumption data can also be transmitted to other display devices via the existing data interfaces for visualization, almost in real time.

A common one-phase or three-phase network connection is used both to supply system 100, or the load manager, and for the measurement of the voltage level and phase position of the supply lines, and also for network connection via power line communication.

Load manager 100 has a low inherent consumption, and can therefore be realized in a closed housing that is protected against installation dirt. The housing can easily be installed in existing distribution boxes using cap rail fastening, or can be installed directly on the wall. Load manager 100 has both built-in interfaces 108 for coupling to existing building automation equipment, such as ZigBee, LON, RS485, etc., and also optionally has a mobile radio interface for alternative coupling to the Internet if DSL or similar access is not present near the installation location. Radio signal antenna terminals wired to the outside also permit operation in shielded metal distribution boxes.

The installed power line communication unit (PLC) couples the data signals to all three phases of the supply network. In this way, terminal devices and other communication devices can be reached independently of their phase affiliation. The PLC unit is designed with a transmission rate of at least 85 Mbit/s, so that it can act as an access point for broadband data transmissions separate from the load management. The PLC communication also offers the advantage that in the case of an onboard charging unit installed in the electric vehicle, communication with the charging unit can take place via a standard power connection cable without special plug connectors. Load manager 100 can also provide the electric vehicle with data from the Internet for range management, such as route data, traffic information, weather information, etc.

The load switching devices, which can also be called end nodes, can be realized as a combination of outlet, plug, switching unit, power line communication module, radio communication module (e.g. ZigBee), and power/energy measurement module. In addition, further functions, such as a temperature measurement for heating control, or a brightness measurement for lighting control, can be additionally integrated in the end nodes, and can be read out via the already-existing communication channels (PLC, radio).

1.-10. (canceled)

11. A method for operating a local energy network that has a limited network utilization and in which a plurality of loads can be connected via a power network, the method comprising:
detecting an energy requirement of each load; and
providing an allocation of an available energy to the loads as a function of a maximum utilization of the energy network, wherein the allocation is carried out by a system that at the same time enables a communication.

12. The method as recited in claim 11, wherein the allocation is carried out on the basis of a prioritization.

13. The method as recited in claim 11, further comprising:
connecting an electric vehicle having a battery as a load.

14. The method as recited in claim 11, further comprising:
carrying out the communication with a user.

15. The method as recited in claim 11, further comprising:
carrying out the communication with another energy network.

16. The method as recited in claim 11, wherein the allocation is less than a corresponding energy requirement.

17. The method as recited in claim 11, wherein the communication takes place via one of the power network and a power line.

18. A system for operating a local energy network that has a limited network utilization and in which a plurality of loads can be connected via a power network, comprising:
an arrangement for detecting an energy requirement of each load; and
an arrangement for providing an allocation of an available energy to the loads as a function of a maximum utilization of the energy network, wherein:
the system enables a communication.

19. The system as recited in claim 18, further comprising:
an arrangement fashioned for enabling communication at least one of in the energy network and with at least one other energy network.

20. The system as recited in claim 18, further comprising:
an arrangement for providing data from the Internet to a connected electric vehicle for the purpose of range management.
